(19) United States
(12) Patent Application Publication
(10) Pub. No.: US 2011/0218928 A1
(43) Pub. Date: Sep. 8, 2011

(54) AUTOMATED LICENSE DETERMINATION

(76) Inventors: THORSTEN REFIOR, Heidelberg (DE); Torsten Zube, Mountain View, CA (US)

(21) Appl. No.: 12/715,574

(22) Filed: Mar. 2, 2010

(51) Int. Cl. G06Q 50/00; G06Q 99/00; G06F 3/048; G06F 17/30

(52) U.S. Cl. 705/310; 715/808; 707/803; 715/764; 715/843; 706/20; 707/E17.044

(57) ABSTRACT

Described herein are methods and systems for automated license determination. In one aspect, an interface repository comprises a set of data schemas defining a license determination rule structure for all available control regulations offered by data providers. In another aspect, license determination rules for a certain product may be automatically extracted from the interface repository.

### FIELD OF THE INVENTION

The invention relates to automated license determination. More precisely, the invention relates to automated license determination for products under national or multinational regulations.

### BACKGROUND OF THE INVENTION

International trade requires the trading parties to comply with common export or import control regulations. Some examples are the US Export Administration Regulations (EAR), US International Traffic in Arms Regulations (ITAR), US Re-Export Regulations, European Dual-Use Export Control, German “Autβenwirtschaftsverordnung” (AWV), and Swiss “Güterkontrolgesetzt” (GKG). In addition, there are other regulations such as Pharmaceutical Laws, Controlled Substances Regulations, Chemical Weapon Agreements, Animal Feed Regulations, Pest Management Regulations, and Waste Management Laws.

Failure to comply with all the relevant regulations when trading with regulated goods could result in costly fines and penalties. Software applications that facilitate trade in such goods gather all export or import related laws, regulations, prohibitions, and constraints and provide them to the trading parties in an unstructured form. This requires the parties to search for the regulations manually and to have intimate knowledge of which regulations apply to which classification of goods, in order to determine the type of licenses and permits required to complete the transaction.

Currently, users have to maintain a license determination rule manually for each possible logistic process. This is due to the fact that the determination rules are structured differently for different jurisdictions. These rules are used to inform whether an export or import of a certain product from/to a specific country is control relevant. Some regulations are maintained in textual format, while others are in some kind of structured format like Extensible Markup Language (XML) format for example. So each country, authority or legislation defines the so-called license determination rules in a different way—sometimes in structured format like XML but often in an unstructured textual format. In addition, different terms and attributes are used to describe a license determination process. To manually transform all these different publications into license determination rules is an enormous effort that increases the total cost of ownership (TCO) especially for companies that operate in multiple countries. Users have to create and maintain license determination rules that conform to different laws and regulations in different countries presented in different formats and languages.

### SUMMARY OF THE INVENTION

Various embodiments of computer implemented methods and systems for automated license determination are described herein. In one embodiment, the method includes receiving a user selection of a classification of a product and generating a user interface comprising a list of one or more conditions relevant to the user selected classification of the product. The method also includes receiving a user selection of the one or more conditions from the list to be applied to the product and generating a user interface comprising a list of one or more license determination rules relevant to the product. The method further includes applying the license determination rule to determine one or more licenses applicable to the export-import of the product.

In another embodiment, the system includes a processor in communication with one or more memory elements and operable to execute the instructions in the one or more memory elements and an interface repository comprising a set of data schemas defining a license determination rule structure. The system also includes a rule data database stored in the one or more memory elements to integrate the license determination rule structure and a registration module stored in the one or more memory elements to save the license determination rule structure in the rule data database.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a flow diagram exemplifying a license determination process.

FIG. 2 is a flow diagram of an embodiment of a method for automated license determination for export-import of a product.

FIG. 3 is a block diagram of an embodiment of a system for automated license determination.

FIG. 4A is a block diagram exemplifying a “classification list” data schema head section for an interface repository.

FIG. 4B is a block diagram exemplifying a “classification list” data schema body section for an interface repository.

FIG. 5 is a block diagram exemplifying a “classification list texts” data schema body section for an interface repository.

FIG. 6A is a block diagram exemplifying a “license determination rules” data schema head section for an interface repository.

FIG. 6B is a block diagram exemplifying a “license determination rules” data schema body section for an interface repository.

FIG. 7 is a flow diagram of an embodiment of a method for automated license determination related to export-import of products.

FIG. 8 is a block diagram of an embodiment for automated license determination.

### DETAILED DESCRIPTION

Embodiments of techniques for automated license determination are described herein. In the following description, numerous specific details are set forth to provide a thorough understanding of embodiments of the invention. One skilled in the relevant art will recognize however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

To determine whether an export or import of a certain product from/to specific country is control relevant, so-called determination rules have to be maintained. The rules may be completely different and may be dependent on various attributes such as product attributes (e.g., classification, product type or group, product specific characteristics), military or civilian usage, country of origin, country of destination, and route. In most cases, the content for those rules can be found in official publications, which are provided in unstructured formats. Considering the amount of products that are imported from vendors or exported to customers in different countries, the number of rules to be defined manually can easily reach an extremely high number.

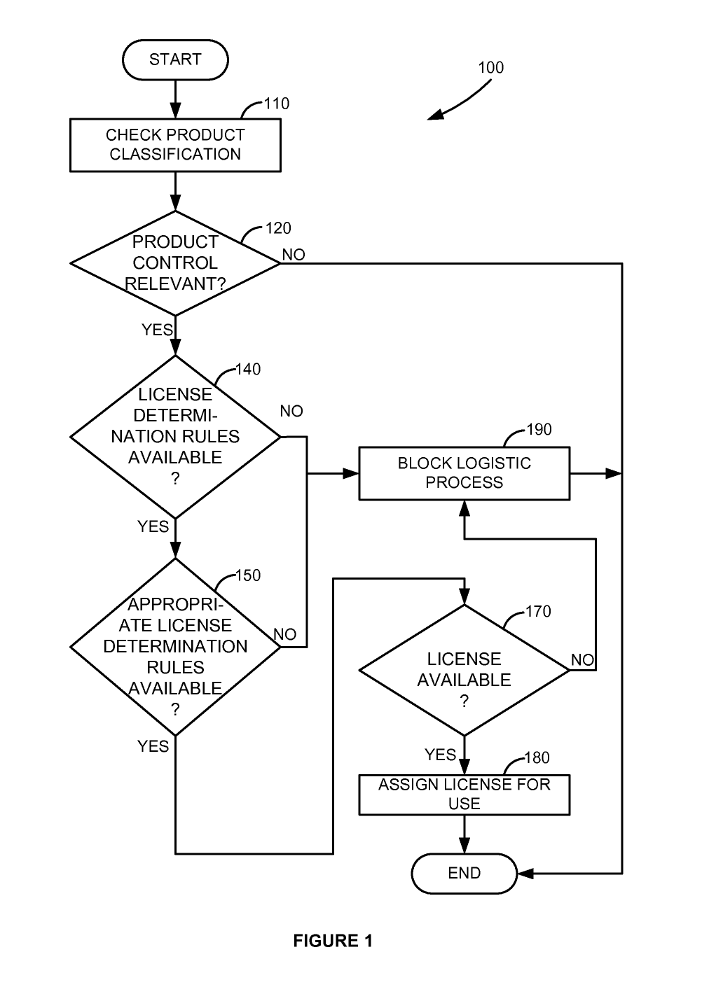

FIG. 1 is a flow diagram 100 exemplifying a license determination process. The process starts at block 110 with checking a product classification. During this step, the product is defined with a classification number or another type of classification code. The product classification identifies a product depending on the product, the product characteristics, and country of origin. Determining the product classification is important for finding any existing product control. Product control determines whether any export or import regulations of a certain product from/to specific country are available. At decision block 120 a check is performed for any relevant product control, i.e., any relevant regulations. If no relevant product control is found in block 120, the license determination process ends. If there is some relevant product control at block 120, then at block 140 is performed a check for available license determination rules. This is a manual step, which may be very time consuming. If, at decision block 140, there are no license determination rules available, then the logistic process is blocked at block 190 and the license determination process ends. If, at decision block 140, there are certain number of license determination rules found, then, at decision block 150 a check is performed to determine if the available license determination rules are appropriate for the product. Appropriate license determination rules are rules that refer to the product with its product characteristics, place of origin, etc. If none of the available rules are appropriate for the product, then the logistic process is blocked at block 190 and the license determination process ends. Otherwise, if appropriate license determination rules are found at decision block 150, the license determination process continues to block 170, where at least one license is defined for the product. If no license has been defined at block 170, then the logistic process is blocked in block 190 and the license determination process ends. If a license is determined at block 170, then the license is assigned for use at block 180.

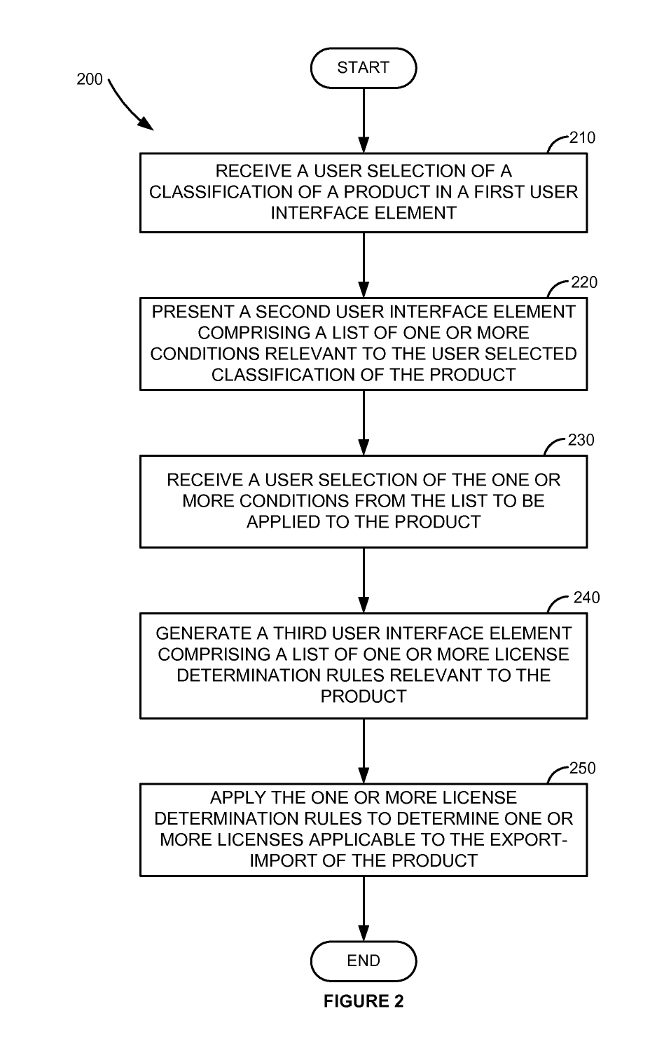

FIG. 2 is a flow diagram of an embodiment of a method 200 for automated license determination for export-import of a product. The process starts at block 210 with receiving a user selection of a classification of the product in a user interface (UI) element. The user defines a class to which the examined product belongs. Thus, the product is bound to a classification number or other type of classification identification. This is necessary, because the regulations refer to a certain classification and to find all the relevant regulations for a product, the product should first be classified. Then, at block 220, a second UI element is presented, comprising a list of one or more conditions relevant to the user selected classification of the product. The conditions are bound to a classification number, for example, but not to the product itself. The classification number may be different for the same product depending, for example, by the location of the product manufacturer. Different locations suppose different regulations to refer to a product. In one embodiment, the conditions are presented in a pop-up window next to the classified product from which the user may select one or more conditions. For example, if the product is a motor engine, a condition may be that if the engine is over 100 hp, then the engine is subjected to a certain import/export tax. Another condition may be that if the motor engine uses diesel as a fuel, then an additional tax should be paid. The next step, at block 230, is receiving a user selection of the conditions from the list to be applied to the product. The user is given a choice to manually select the conditions that apply for the examined product. In one embodiment, this selection is performed by selecting “yes” or “no” from a drop-down menu next to each condition. Based on the selected conditions, at block 240 a third UI element is generated comprising a list of one or more license determination rules relevant to the examined product. In one embodiment, the license determination rules contain information about the country of export, country of import, a classification number, and conditions assigned to the classification number. At block 250, the one or more license determination rules are applied to determine one or more licenses applicable to the export-import of the products.

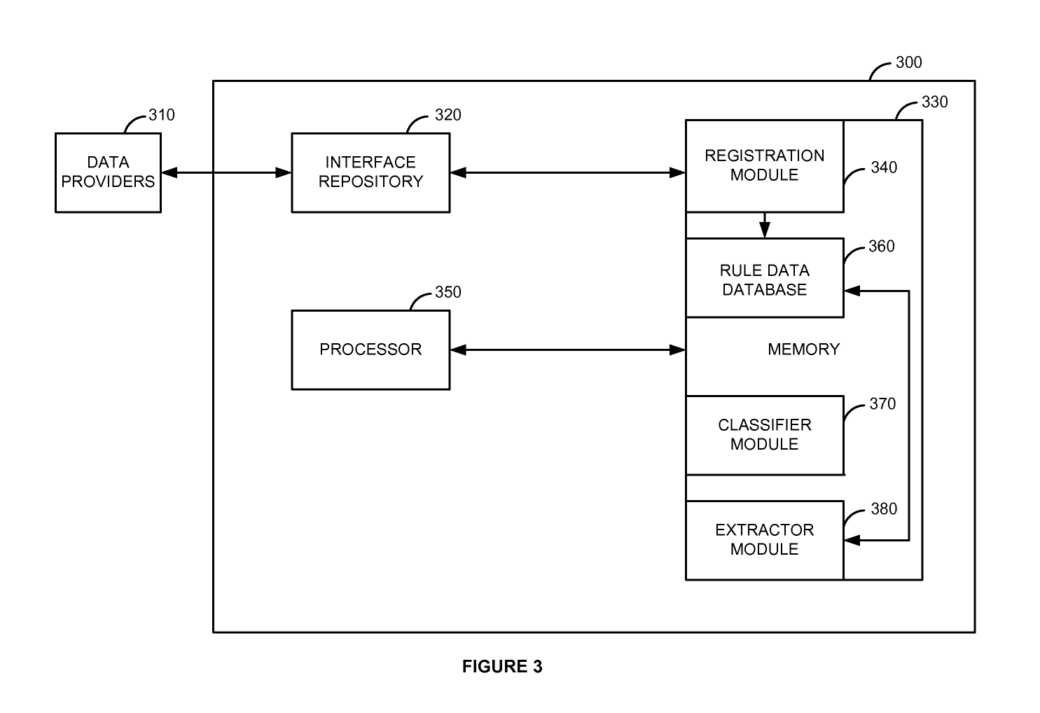

FIG. 3 is a block diagram of an embodiment of a system 300 for automated license determination. The system includes memory 330, and a processor 350 and an interface repository 320 in communication with the memory 330. The processor 350 is able to execute instructions in the memory 330. Within the memory 330 there are a registration module 340, a rule data database 360, a classifier module 370, and an extractor module 380. The interface repository 320 offers data structures in self-descriptive human-machine readable data, such as, a markup language like XML format, so that data providers 310 are able to map their data to the interface repository 320. Where the rules are in XML format the interface repository 320 may be defined by one or more XML Schema Definition files.

The interface repository 320 is used to create a set of license determination rules. These rules are used to inform whether an export or import of a certain product from/to specific country is control relevant. Data providers 310 receive a set of interfaces to the interface repository 320. They input the regulations, laws, prohibitions, practices, constraints and the like, as well as any annotations or ancillary information on the same, collectively data, into the interfaces. The data can be both structured and unstructured, e.g., text. The input process maps this to structured data. The data providers 310 make the interfaces with data in them available through sale, previous agreement, at no cost or the like. The data providers 310 may be governments, consultants, standards bodies, vendors of an enterprise resource planning, supply chain management, or transportation management, or trade regulation compliance system, service or software, or, owners of the same, and the like. The data is accepted by the interface repository 320 and saved by a registration module 340 to a rule data database 360. Thus a whole license determination rule structure is created, which is saved for further use in the rule data database 360. In some embodiments, a classifier module 370 is used to classify a user selected product as part of a license determination rule process. In some embodiments, an extractor module 380 is used to extract relevant determination rules for a classified product from the rule data database 360. This may be done, for example, by means of the method described in FIG. 2.

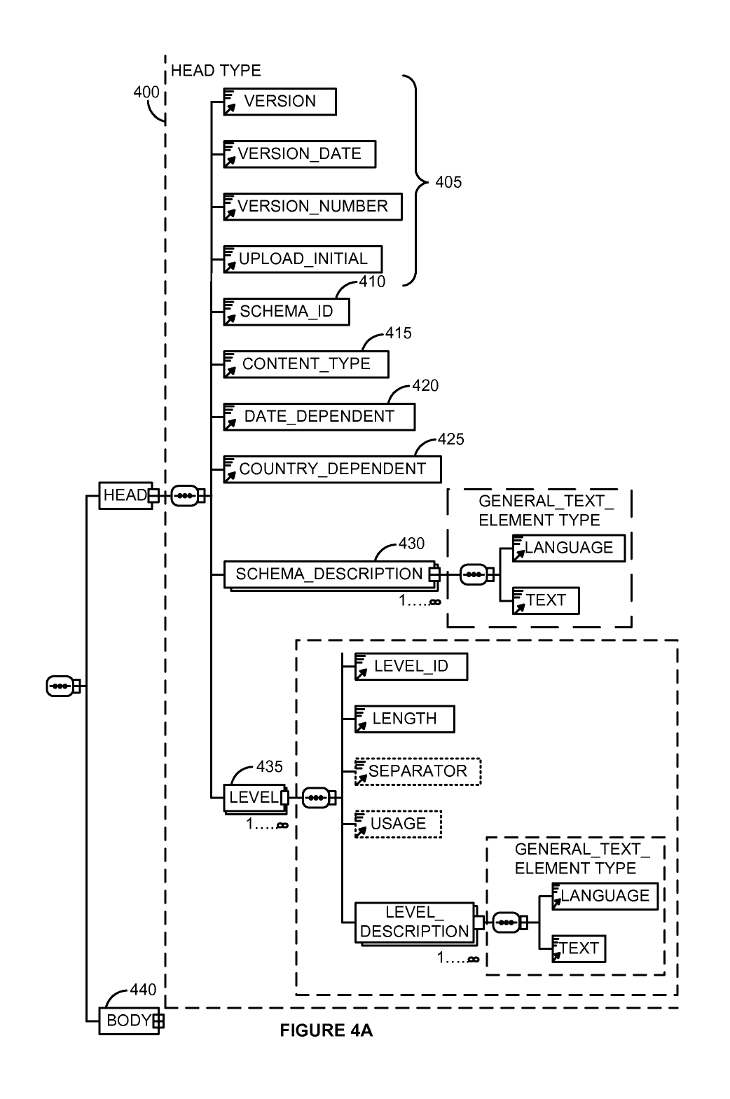

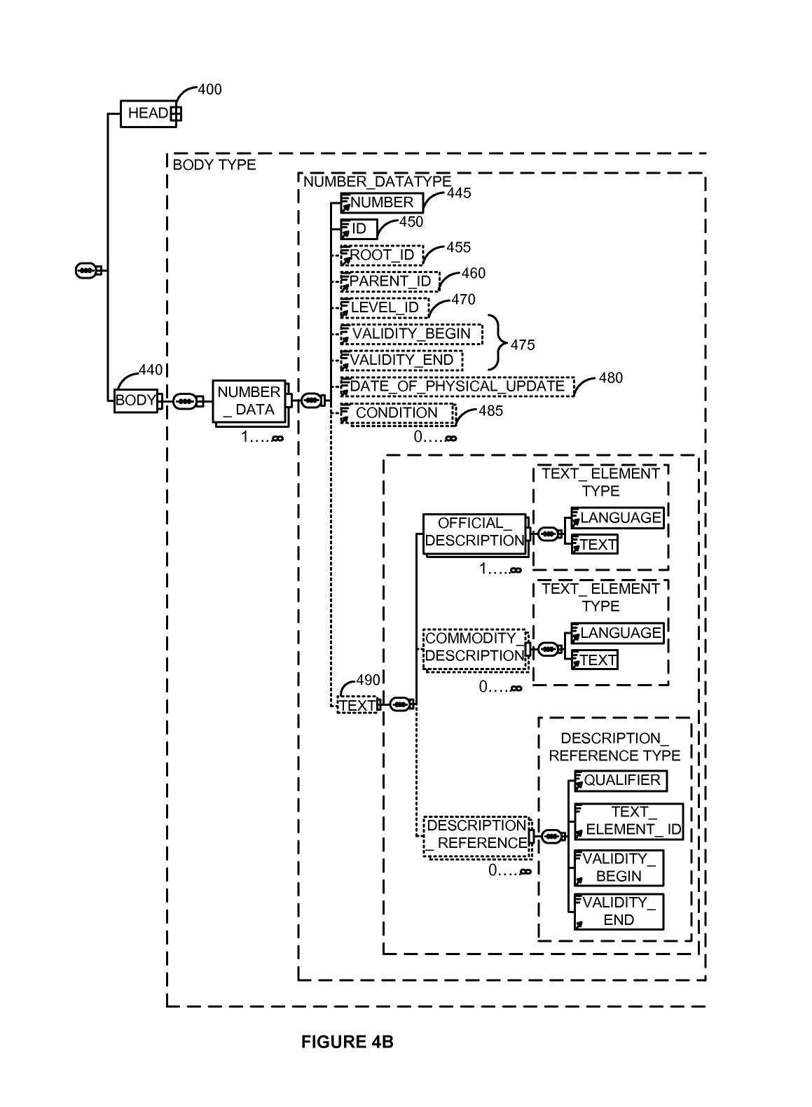

In some embodiments, the interface repository 320 includes the following schemas: a “classification list” schema, a “classification list texts” schema, a “classification list condition” schema, and a “license determination rules” schema. In one embodiment, the “classification list” schema is organized as the exemplary data schema presented in FIG. 4A. The “classification list” schema defines a classification system for the products examined for related licenses. In this embodiment, the classification list schema head section 400 comprises a “schema identification (ID)” field 410, a “content type” field 415, a “date dependent” field 420, a “country dependent” field 425, a “schema description” field 430, and a “level” field 435. The rest of the fields 405 contain specific administrative data such as version, version date, and version number. The “schema identification” field 410 contains a unique ID to register a classification system. A schema defines a classification system within a country or country group. The “content type” field 415 is to describe the classification system provided. The next field “date dependent” 420 is to define whether the classification system is date dependent or not. The “country dependent” field 425 defines whether the classification system is country dependent or not. The “schema description” field 430 is to provide textual description of the classification system in any language. The “level” field 435 is to define the structure of the classification system that controls the user interface presentation. The body section 440 of the schema is described with reference to FIG. 4B. The body section 440 contains an abstract of the actual content. Any kind of classification content, respectively any level of classification content may be represented according to the structure defined in the head section 400. In the current embodiment, the content of the body section 440 is as presented in FIG. 4B. The content of the body section 440 is presented in the following table:

| Field | Description of the field content |
|---|---|
| number 445 | Category, grouping, chapter, positions, or entire |
| | classification code |
| ID 450 | Global Unique Identifier (GUID) that identifies the |
| | number in the “number” field 445 |
| root ID 455 | Reference to the first records within the file |
| parent ID 460 | Parent ID of the hierarchy. It refers to the next higher |
| | records in the hierarchy. |
| level ID 470 | Reference to the structure definition |
| validity begin and | Definition of the validity of each number in |
| validity end 475 | the “number” field 445 |
| date of physical | Date when original source created or updated the |
| update 480 | record |
| condition 485 | Reference to condition in a “Classification list |
| | condition” schema |
| Texts 490 | Includes texts and text references. Any text type |
| | may be used. |

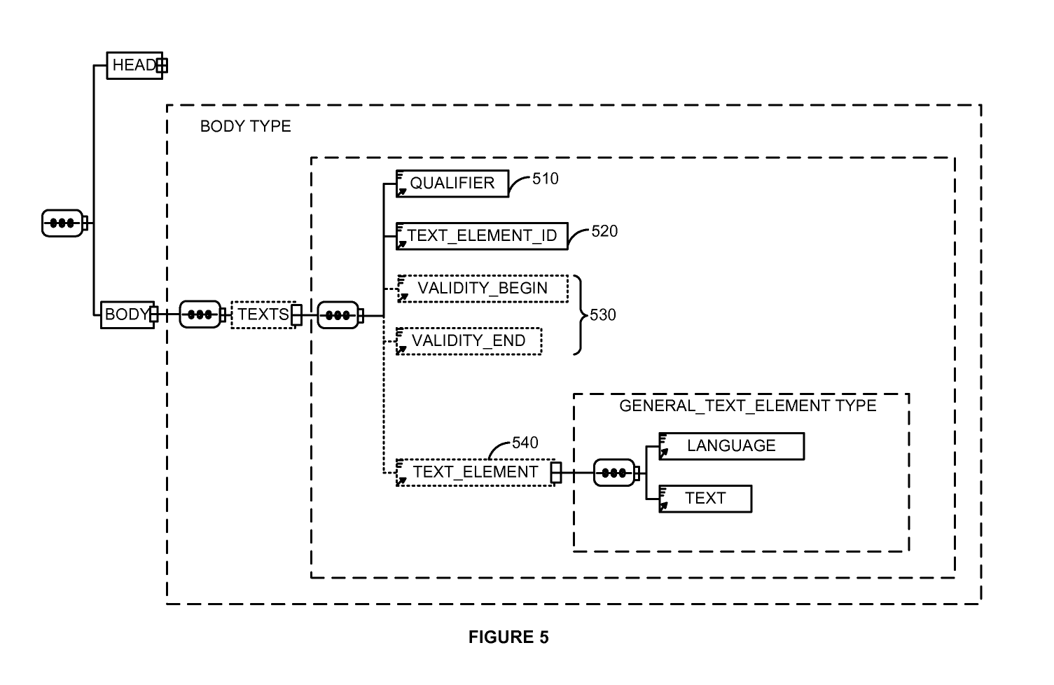

In the “classification list” schema, any type of dependent text as well as reference to any type of independent text can be assigned to a classification code. A dependent text is any text that is assigned to one number only, such as official or commodity descriptions. An independent text is any text that can be assigned to one or more numbers, such as explanations, general hints, chapter notes, annotations, footnotes and the like. The “classification list texts” schema defines how to provide independent texts. The head section of the “classification list texts” schema is almost identical to the one of the “classification list” schema, except for the missing fields “schema description” 430 and “level” 435. The body section of the “classification list texts” schema is shown in FIG. 5. The content of the body section is presented in the following table:

| Field | Description of the field content |
|---|---|
| qualifier 510 | Specifies the text type, for example, annotation, |
| | footnote and the like. |
| text element ID | Global Unique Identifier (GUID) to identify the text |
| 520 | object; the text element ID 520 is assigned to a number |
| | in the “number” field 445 in the “classification list” |
| | schema. |
| validity begin and | Validity of each text object. |
| validity end 530 | |
| text element 540 | Text of the text object in any language. |

A decision, whether a rule is eligible cannot be made on a common classification code. Often rules are dependent on conditions that are not specified in the “classification list” schema. The “classification list condition” schema defines the structure to provide conditions that can be both generic and specific. A condition is, though, a completely different type of classification system. Unlike the classification code, the condition is not directly assigned to a product but rather to a classification code.

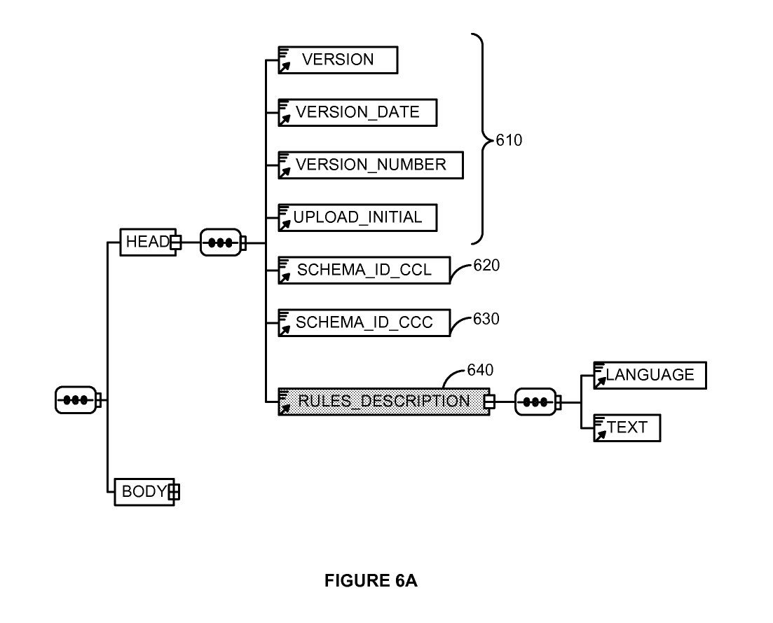

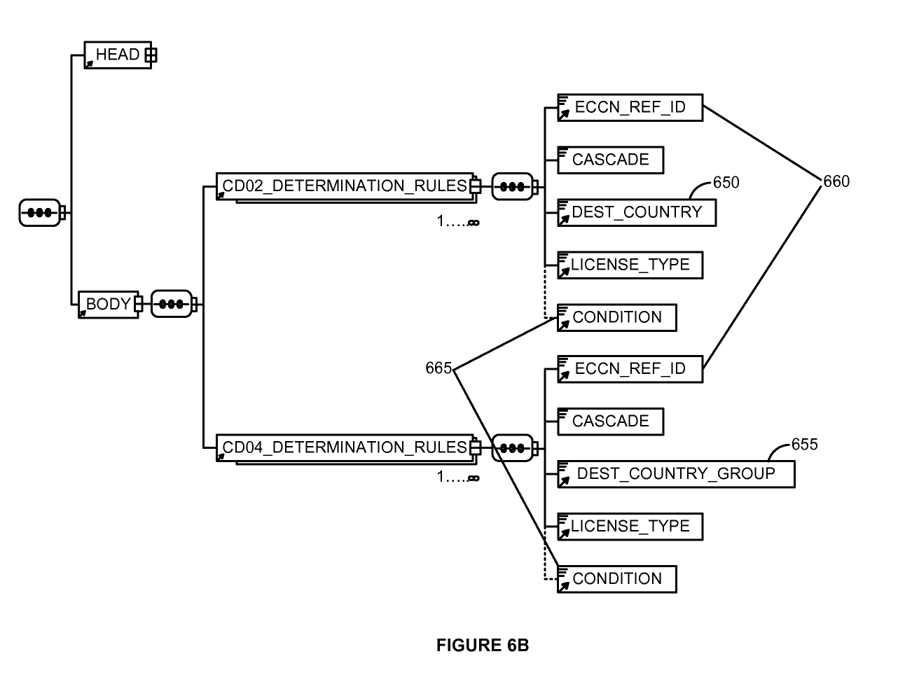

A license determination rule defines which license type is required by considering the product classification, the country or country group of destination, and conditions. The “license determination rules” schema defines the structure to provide determination rules. The head section of the “license determination rules” schema, as presented in FIG. 6A, includes some specific administrative data 610 such as version, version date, version number, and initial upload. The head section also defines the classification system by “schema ID CCL” field 620, as well as the conditions by “schema ID CCC” field 630, to which the rules refer to. The “rules description” 640 field provides a general description of the rules. The body section of the “license determination rules” schema is presented in FIG. 6B. The body section contains the rules, which are divided into country (“dest_country” field 650) and country group (“dest_country_group” field 655) dependent rules. Each rule refers to a classification code (“eccn_ref-ID” field 660) and one or more conditions (“condition” field 665). The classification code (“eccn_ref-ID” field 660) refers to “classification list” schema, while conditions (“condition” field 665) refer to “classification list condition” schema. The classification list schema is so named in FIG. 6B for the commonly used Export Control Classification Numbers (ECCN). These are specific alpha-numeric codes attributed by US regulators to items for the purposes of identifying levels of export control or controls.

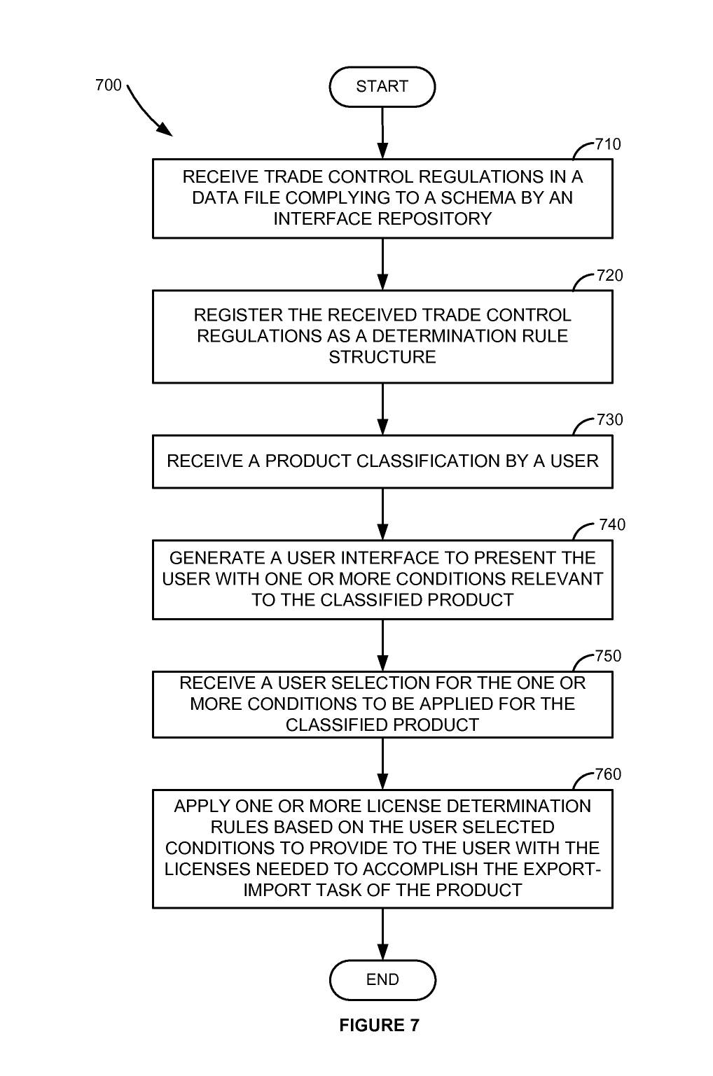

FIG. 7 is a flow diagram of an embodiment of a method 700 for automated license determination related to export-import of products. The method starts with receiving trade control regulations in a data file complying to a schema by an interface repository at block 710. In one embodiment the interface repository includes a “classification list” schema, a “classification list texts” schema, a “classification list condition” schema, and a “license determination rule” schema. In the “classification list” schema any type of dependent text, as well as reference to any type of independent text can be assigned to a classification code. The “classification list texts” schema defines a structure to provide independent text. The “classification list condition” schema comprises one or more conditions assigned to a classification code. The “license determination rules” schema defines a structure to provide determination rules. Referring again to FIG. 7, at block 720, the received trade control regulations are registered as a determination rule structure bound to a product classification. In one embodiment, the determination rule structure is saved in a rule data database. At block 730 a user selection for a product classification is received. The classification of the product is defined by the user by means of product attributes such as product type, country of manufacturer and other product relevant data. At block 740, the user is presented a UI element with one or more conditions relevant to the classified product. At block 750 the user has to manually select which conditions are to be applied for the classified product. Finally, at block 760, one or more license determination rules are applied, bound to the user provided product classification, to provide the user with the licenses needed to accomplish the export-import task of the products.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable medium as instructions. The term “computer readable medium” should be taken to include a single medium or multiple media that stores one or more sets of instructions. The term “computer readable medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer-readable media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

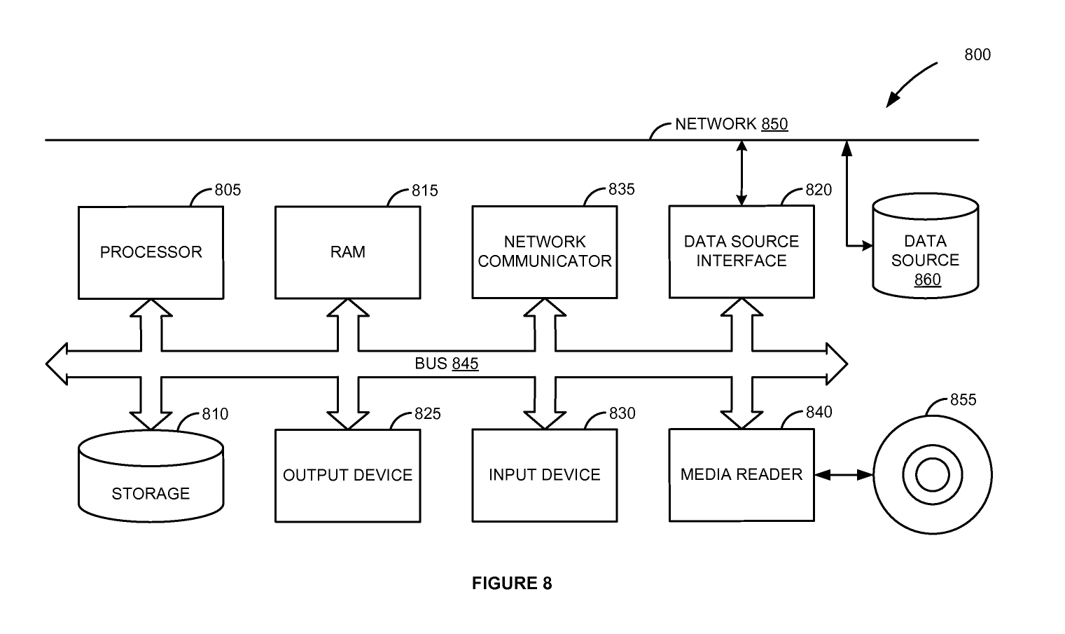

FIG. 8 is a block diagram of an exemplary computer system 800. The computer system 800 includes a processor 805 that executes software instructions or code stored on a computer readable medium 855 to perform the above-illustrated methods of the invention. The computer system 800 includes a media reader 840 to read the instructions from the computer readable medium 855 and store the instructions in storage 810 or in random access memory (RAM) 815. The storage 810 provides a large space for keeping static data where at least some instructions could be stored for later execution. The stored instructions may be further compiled to generate other representations of the instructions and dynamically stored in the RAM 815. The processor 805 reads instructions from the RAM 815 and performs actions as instructed. According to one embodiment of the invention, the computer system 800 further includes an output device 825 (e.g., a display) to provide at least some of the results of the execution as output including, but not limited to, visual information to users and an input device 830 to provide a user or another device with means for entering data and/or otherwise interact with the computer system 800. Each of these output devices 825 and input devices 830 could be joined by one or more additional peripherals to further expand the capabilities of the computer system 800. A network communicator 835 may be provided to connect the computer system 800 to a network 850 and in turn to other devices connected to the network 850 including other clients, servers, data stores, and interfaces, for instance. The modules of the computer system 800 are interconnected via a bus 845. Computer system 800 includes a data source interface 820 to access data source 860. The data source 860 can be access via one or more abstraction layers implemented in hardware or software. For example, the data source 860 may be accessed through network 850. In some embodiments the data source 860 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A computer implemented method for automated license determination for export-import of a product, comprising:
in a first user interface element, receiving a user selection of a classification of the product;
presenting a second user interface element generated by the computer comprising a list of one or more conditions relevant to the user selected classification of the product;
receiving a user selection of the one or more conditions from the list to be applied to the product;
based on the user selected conditions, generating a user interface comprising a list of one or more license determination rules relevant to the product; and
applying the license determination rule to determine one or more licenses applicable to the export-import of the product.

2. The method of claim 1, wherein the product classification received by the user is a classification number.

3. The method of claim 1, wherein the list with one or more conditions relevant to the classified product appears as a pop-up window next to the classified product.

4. The method of claim 1, wherein the user selection for the conditions to be applied is performed by selecting “yes” or “no” from a drop-down menu next to each condition.

5. The method of claim 1, wherein the determination rules comprise:
a classification number;
one or more conditions assigned to the classification number;
at least one country of the export; and
at least one country of the import.

6. A computer readable medium comprising computer readable instructions, which, when executed by a computer, cause the computer to perform a method related to export-import of products, the method comprising:
receiving trade control regulations in a data file complying to a schema by an interface repository;
registering the received trade control regulations as a determination rule structure by binding the received trade control regulations to a product classification;
receiving the product classification by a user;
generating a user interface to present the user with one or more conditions relevant to the classified product;
receiving a user selection of the one or more conditions to be applied for the classified product; and
based on the user selected conditions, applying one or more license determination rules bound to the user provided product classification to provide the user with the licenses needed to accomplish the export-import task of for the products.

7. The medium of claim 6, wherein the interface repository further comprises:
classification list schema;
classification list texts schema;
classification list condition schema; and
license determination rules schema.

8. The medium of claim 7, wherein the classification list schema comprises dependent text and independent text assigned to a classification code.

9. The medium of claim 7, wherein the classification list texts schema comprises data structure for independent text.

10. The medium of claim 7, wherein the classification list condition schema further comprises one or more conditions assigned to a classification code.

11. The medium of claim 7, wherein the license determination rules schema comprises a data structure for determination rules.

12. The medium of claim 6, wherein the determination rule structure is saved in a rule data database.

13. A computer system for automated license determination, comprising:
a processor in communication with one or more memory elements and operable to execute the instructions in the one or more memory elements;
an interface repository comprising a set of data schemas defining a license determination rule structure;
a rule data database stored in the one or more memory elements to integrate the license determination rule structure; and
a registration module stored in the one or more memory elements to save the license determination rule structure in the rule data database.

14. The system of claim 13 further comprising a classifier module within the memory to classify a user selected product.

15. The system of claim 14 further comprising an extractor module to extract relevant determination rules for the classified product from the rule data database.

16. The system of claim 13, wherein the set of data schemas defining a license determination rule structure comprises:
a classification list schema;
a classification list text schema;
a classification list condition schema; and
a license determination rule schema.

17. The system of claim 16, wherein the classification list schema comprises:
a “number” field for a classification code;
a “condition” field, which is reference to the classification list condition schema; and
a “texts” field, which includes texts and reference to the classification list text schema.

18. The system of claim 16, wherein the classification list text schema comprises a “text element” field for text of text object in any language.

19. The system of claim 16, wherein the classification list condition schema comprises a “texts” field for describing a condition assigned to a classification code.

20. The system of claim 16, wherein the license determination rules schema comprises:
a “rules description” field;
one or more “condition” fields for one or more conditions assigned to one license determination rule.
